(19) United States
(12) Patent Application Publication
(10) Pub. No.: US 2024/0006110 A1
(43) Pub. Date: Jan. 4, 2024

(54) TRANSFORMER

(71) Applicant: Shenzhen Apesilicon Semiconductor Co., Ltd., Shenzhen (CN)

(72) Inventors: Lianfu HUANG, Shenzhen (CN); Zhiyuan HUANG, Shenzhen (CN)

(73) Assignee: Shenzhen Apesilicon Semiconductor Co., Ltd., Shenzhen (CN)

(21) Appl. No.: 18/191,234

(22) Filed: Mar. 28, 2023

(30) Foreign Application Priority Data
Jul. 1, 2022 (CN) 202210767867.4

(51) Int. Cl. H01F 27/00; H01F 27/24; H01F 27/40; H01M 50/51; H01M 10/052

(52) U.S. Cl. CPC H01F 27/004; H01F 27/24; H01F 27/40; H01M 50/51; H01M 10/052

(57) ABSTRACT

This present disclosure discloses a transformer. The transformer comprises a lithium battery pack, a transformer coil and 2N switches. The lithium battery pack comprises N single batteries connected in series. The transformer coil comprises a magnetic core, N first windings and N second windings. The N first windings combined into one strand, the N second windings combined into one strand, are then wound on the magnetic core respectively. The N first windings and the N second windings have same number of coil turns, same homonymous ends and same common ends. Two ends of each single battery are connected with one first of the first windings and one of the second windings in parallel respectively. Each first winding is connected with one switch in series. Each second winding is connected with one switch in series. N is a natural number greater than or equal to 1.

### CROSS-REFERENCE TO RELATED APPLICATION

This application claims priority under 35 U.S.C. § 119(a) to and the benefit of Chinese Patent Application No. 202210767867.4, filed Jul. 1, 2022, the entire disclosure of which is incorporated herein by reference.

### TECHNICAL FIELD

The present disclosure relates to winding structure of transformer coils, and in particular to a transformer having a winding structure of the transformer coil.

### BACKGROUND

The inconsistency of parameters such as voltage, capacity or internal resistance of the signal batteries in the lithium battery pack (B) is inevitable during a manufacturing and use process, and it is a continuous accumulation process, and the longer the time the difference between the signal batteries becomes bigger. In addition, the lithium battery pack (B) will be affected by the use environment, and the inconsistency of the signal batteries will be gradually amplified during the use process, which leads to the accelerated decay of the performance of some signal batteries.

In the prior art, in the equalization transformer for a lithium battery pack with n signal batteries connected in series, as shown in FIG. 1, the existing multiplex transformer structure includes a primary winding L0 and n secondary sub-windings (L1, L2, . . . , Ln). The number of coil turns of the n secondary sub-windings are all the same, and their sum is equal to the number of coil turns of the primary winding L0. In this battery equalization process, when the high-frequency varying current flows in the various windings of the equalization transformer, the induced electromotive force U1, U2, . . . Un will be generated at the end of each sub-winding and the induced electromotive force U0 will be generated at the end of the primary winding. According to Faraday's electromagnetic induction principle, the induced electromotive force of each winding is positively related to the number of coil turns n of the winding, with U1/N1=U2/N2= . . . =Un/Nn=(U1+U2+ . . . Un)/N0. If the induced electromotive force>battery voltage UB, the battery will be charged and there will be current flowing into the battery through the equalizing winding of the transformer; if the battery voltage UB>induction voltage, the battery provides electrical energy to the equalizing winding and the current flows out from the battery and flows in from the equalizing winding. When N1=N2= . . . Nn, it can ensure U1=U2= . . . Un and finally achieve the battery voltage equalization.

The multiplex transformer winding method in the prior art is a split asynchronous winding method, in which the primary winding is wound first and then the secondary sub-windings are wound separately during the transformer fabrication process. The coil is wound on the magnetic core of the transformer is a complete coil turn, because each winding of the transformer eventually have to be tapped out to form an independent pin, the lead out position of each pin of the split asynchronous winding will lead to a small error among the number of coil turns of each winding. In this way, the actual winding of N1≈N2≈ . . . ≈Nn≈NO≈(N1+N2+ . . . Nn). According to Faraday's principle of electromagnetic induction, the small coil turns count error between the actual winding of N1, N2, . . . , Nn will lead to that the induction voltage of each secondary sub-winding will not be identical when the equalization transformer works, but there is a certain voltage difference. This voltage difference is expressed as the equalization voltage error of the equalization transformer, defined as the maximum value of the equalization voltage difference of each string of signal batteries ΔU=MAX (Ui−Uj) (i, j are between 1 and n).

The equalization transformer of this split asynchronous winding method in the prior art has a large difference in inductance between the N secondary sub-windings, and the sum of the inductance of the N secondary sub-windings also has a large error with the sum of the inductance of the primary windings. In the actual equalization application, it can only do the equalization accuracy of 20 mV, which is difficult to reduce the voltage difference between the batteries, and can not meet the requirements of battery equalization well.

### SUMMARY

In response to the shortcomings of the prior art in voltage accuracy, the present disclosure provides a transformer which realizes multiple integrated synchronous winding, which is significantly improved compared to the 20 mV accuracy of the prior art and can meet the battery equalization requirements more efficiently and finely, with the following technical solutions:

The present disclosure discloses a transformer. The transformer comprises a lithium battery pack, a transformer coil and n switches. The lithium battery pack comprises n single batteries connected in series. The transformer coil comprises a magnetic core, N first windings and N second windings. The N first windings combined into one strand, the N second windings combined into one strand, are then wound on the magnetic core respectively. The N first windings and the N second windings have same number of coil turns, same homonymous ends and same common ends. Two ends of each single battery are connected with one of the first windings and one of the second windings in parallel respectively. Each first winding is connected with one switch in series. Each second winding is connected with one switch in series. Wherein N is a natural number greater than or equal to 1.

Optionally, the N first windings and the N second windings cooperatively use the magnetic core.

Optionally, the magnetic core is at least one of a circular-shape, E-type, C-type and U-type core.

Optionally, the magnetic core comprises a start end and an opposite end, N winding lines are combined into one strand and wound around the magnetic core starting from the start end of the magnetic core and winding a first number of coil turns in a first winding direction to reach the opposite end of the magnetic core, wherein the N winding lines are not cut off and parts of the N winding lines with predefined length are reserved for intermediate taps, and then the N winding lines are continued to be wound in the first winding direction to reach the start end, wherein starting threads of N winding lines are first ends, the intermediate taps of the N winding lines are the common ends and the ending threads of the N winding lines are second ends; each winding line comprises one of the first ends, one of the common ends, and one of the second ends, forming a first winding between the first end and the common end, and forming a second winding between the common end and the second end.

Optionally, the transformer further comprises a transformer frame; the transformer frame comprises a plurality of first end lead pins, a plurality of common end lead pins and a plurality of second end lead pins; the first ends of the N winding lines are connected to the plurality of first end lead pins of the transformer frame, respectively; the common ends of the N winding lines are connected to the plurality of common end lead pins of the transformer frame, respectively; the second ends of the N winding lines are connected to the plurality of second end lead pins of the transformer frame, respectively.

Optionally, the transformer frame is a “ [symbol] ” shaped structure; the transformer frame comprises three parallel sides; the three parallel sides are provided with a row of the common end lead pins, a row of the first end lead pins and a row of the second end lead pins. The number of the common end lead pins is not less than the number of the single batteries in the lithium battery pack. The number of the first end lead pins is not less than the number of the single batteries in the lithium battery pack. The number of the second end lead pins is not less than the number of the single batteries in the lithium battery pack.

Optionally, the three parallel sides are non-equally spaced and cooperatively form two rectangular structures of different sizes; wherein the larger rectangular structure receives the transformer coil with completed winding.

Optionally, the single battery comprises a positive terminal and a negative terminal. The common end lead pins are connected to the positive terminal of the single battery, and the first end lead pins are connected together with the second end lead pins to the negative terminal of the single battery.

Optionally, the magnetic core comprises a start end and an opposite end, N winding lines are combined into one strand; the N winding lines are wound around the magnetic core starting from the start end of the magnetic core and winding a second number of coil turns in a first winding direction to pass through the opposite end of the magnetic core and then reach to the start end of the magnetic core; the n winding lines are not cut off and parts of the N winding lines with predefined length are reserved for intermediate taps; the n winding lines are continued to be wound in the first winding direction for the second number of coil turns and again returns to the start end of the magnetic core; wherein starting threads of the N winding lines are first ends, the intermediate taps of the N winding lines are common ends and ending threads of the N winding lines are second ends; each winding line comprises one of the first ends, one of the common ends, and one of the second ends, forming a first winding between the first end and the common end, and forming a second winding between the common end and the second end.

Optionally, the transformer further comprises a transformer frame; the transformer frame comprises a plurality of first end lead pins, a plurality of common end lead pins and a plurality of second end lead pins; the first ends of the N winding lines are connected to the plurality of first end lead pins of the transformer frame; the common ends of the N winding lines are connected to the plurality of common end lead pins of the transformer frame, and the second ends of the N winding lines are connected to the plurality of the second end lead pins of the transformer frame.

Optionally, the transformer frame is a “ [symbol] ” shaped structure; the transformer frame comprises three parallel sides; the three parallel sides are provided with a row of the common end lead pins, a row of the first end lead pins and a row of the second end lead pins; the number of the common end lead pins is not less than the number of the single batteries in the lithium battery pack; the number of the first end lead pins is not less than the number of the single batteries in the lithium battery pack; the number of the second end lead pins is not less than the number of the single batteries in the lithium battery pack.

Optionally, the three parallel sides are non-equally spaced and cooperatively form two rectangular structures of different sizes; wherein the larger rectangular structure receives the transformer coil with completed winding.

Optionally, the single battery comprises a positive terminal and a negative terminal. The common end lead pins are connected to the positive terminal of the single battery, and the first end lead pins are connected together with the second end lead pins to the negative terminal of the single battery.

Compared with the prior art, the present disclosure has the beneficial effects of:

In the transformer of the present disclosure, each winding has high consistency of applied coil turns value, high consistency of inductance, therefore, equalization precision of leaded battery is high, and difference of equalization voltage of each string of batteries is significant reduced, which can well meet the requirements of battery equalization and significantly extend the life of multi-string lithium battery system.

### BRIEF DESCRIPTION OF THE DRAWINGS

In order to explain the technical solutions of the embodiments of the present disclosure more clearly, the following briefly introduces the accompanying drawings that need to be used in the implementation manner. Obviously, the accompanying drawings described below are some embodiments of the present disclosure, for those of ordinary skill in the art, other drawings can also be obtained from these drawings without creative work.

FIG. 1 is a circuit schematic diagram of an existing multiplex transformer with split asynchronous winding way;

FIG. 2 is a circuit schematic diagram of a transformer with multiple integrated synchronous winding according to one embodiment of the present disclosure;

FIG. 3 is a schematic diagram of a winding method with multiple integrated synchronous winding according to one embodiment of the present disclosure;

FIG. 4 is a schematic diagram of a transformer frame structure with multiple integrated synchronous winding according to one embodiment of the present disclosure;

FIG. 5 is a schematic diagram of a combination structure of the transformer frame and the transformer coil of the transformer with multiple integrated synchronous winding according to one embodiment of the present disclosure.

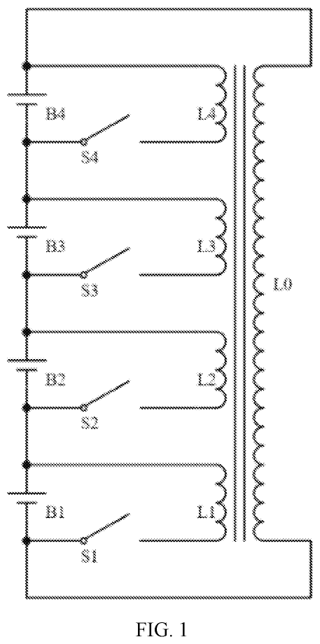

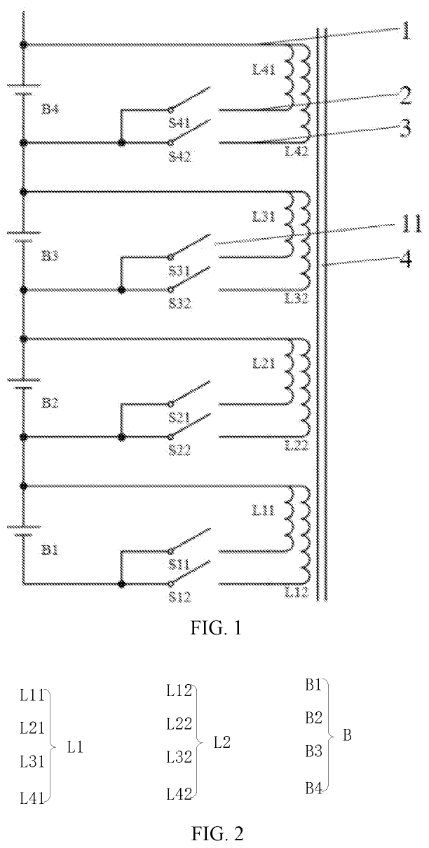

In the drawings: common end 1; first end 2; second end 3; magnetic core 4; start end 5; opposite end 6; common end lead pin 7; first end lead pin 8; second end lead pin 9; transformer frame 10; switch 11; transformer coil 12.

### DETAILED DESCRIPTION OF THE EMBODIMENTS

The technical solutions in the embodiments of the present disclosure will be clearly and completely described below with reference to the drawings in the embodiments of the present disclosure. Obviously, the described embodiments are only a part of the embodiments of the present disclosure, but not all of the embodiments. Based on the embodiments in the present disclosure, all other embodiments obtained by those of ordinary skill in the art without creative efforts fall within the protection scope of the present disclosure.

Unless otherwise defined, all technical and scientific terms used herein have the same meaning as commonly understood by one of ordinary skill in the technical field to which the present disclosure belongs. The terms used herein in the specification of the present disclosure are for the purpose of describing particular embodiments only, and are not intended to limit the present disclosure.

The terms “first”, “second” and the like in the description and claims of the present disclosure and the above drawings are used to distinguish different objects, rather than to describe a specific order. The terms like “a,” “an,” or “the” used in the present disclosure also do not denote a limitation of quantity, but are merely used to denote at least one. The words “comprise” or “include” and similar words mean that the elements or things appearing before the word encompass the elements or things recited after the word and their equivalents, but do not exclude other elements or things. The word “connected” or similar words are not limited to physical or mechanical connections, but may include electrical connections, whether direct or indirect.

In the description of this specification, the terms “embodiment”, “specific embodiment”, “example”, and the like means that a particular feature, structure, material or characteristic described in connection with the embodiment or example is included in at least one of embodiment or example of the present disclosure. In this specification, schematic representations of the above terms do not necessarily refer to the same embodiment or example. Furthermore, the particular features, structures, materials or characteristics described may be combined in any suitable manner in any one or more embodiments or examples.

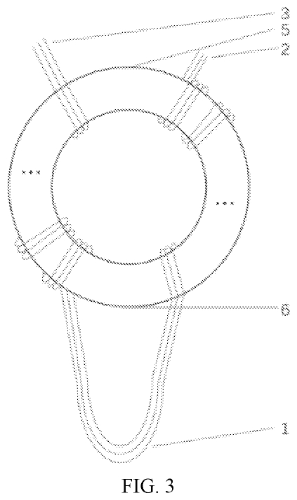

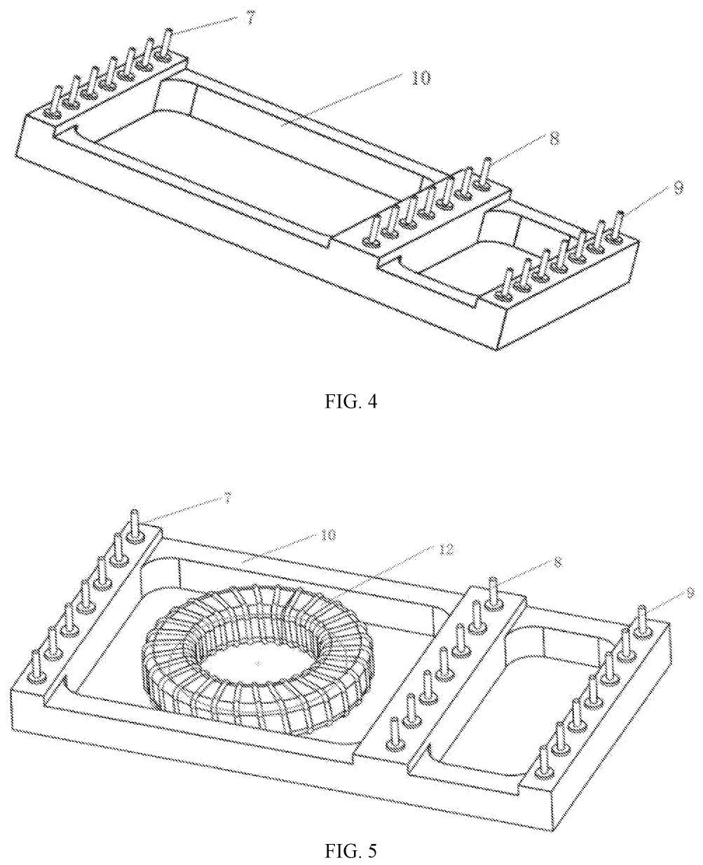

Referring to FIGS. 2 to 5, FIG. 2 is a circuit schematic diagram of a transformer with multiple integrated synchronous winding according to one embodiment of the present disclosure; FIG. 3 is a schematic diagram of a winding method with multiple integrated synchronous winding according to one embodiment of the present disclosure; FIG. 4 is a schematic diagram of a transformer frame structure with multiple integrated synchronous winding according to one embodiment of the present disclosure; FIG. 5 is a schematic diagram of a combination structure of the transformer frame and the transformer coil of the transformer with multiple integrated synchronous winding according to one embodiment of the present disclosure.

As shown in FIGS. 2 and 5, the transformer 100 includes a lithium battery pack B, a transformer coil 12 and 2N switches 11. The lithium battery pack B includes N single batteries connected in series. The transformer coil 12 includes a magnetic core 4, N first windings L1 and N second windings L2. The N first windings L1 combined into one strand, the N second windings L2 combined into one strand, and are respectively wound on the magnetic core 4. The N first windings L1 and N second windings L2 have same number of coil turns, same homonymous ends and same common ends 1. Two ends of each single battery are respectively connect in parallel with one of the first windings L1 and one of the second windings L2. Each first wingding L1 is connected with one switch 11 in series; each second winding L2 is connected with one switch 11 in series. N is a natural number greater than or equal to 1.

Therefore, the windings of the transformer 100 do not distinguish the primary winding from the secondary windings. All windings (i.e., the N first windings L1 and the N second windings L2) have the same number of coil turns, the same eponymous end and same common ends. Each single battery in the lithium battery pack B is connected in parallel with two windings having same number of coil turns, same first ends, same second ends and same common ends (i.e., one first winding L1 and one second winding L2). N single batteries connected in series use 2N windings (i.e., the N first windings L1 and N second windings L2). Each winding has high consistency of applied coil turns value, high consistency of inductance, therefore, equalization precision of leaded battery is high, and difference of equalization voltage of each string of batteries is significant reduced, which can well meet the requirements of battery equalization and significantly extend the life of multi-string lithium battery system.

The eponymous end is the same polarity terminals of the first windings L1 and the second windings L2. For example, when winding two or more coils, a starting thread of the first winding L1 is called as a first end, and an ending thread of the first winding L1 is called as a second end, then the second winding L2 is wound in the same direction as the first winding L1, the first end of the first winding L1 and the first end of the second winding L2 are called as the eponymous end, and the first end of the first winding L1 and the second end of the second winding L2 are called as non-eponymous end. That is to say: the so-called eponymous end is, when the first winding L1 and the second winding L2, pass alternating current (or direct current to produce a static magnetic field) and the direction of magnetic flux superposition (the same direction), the current inflow ends of the first winding L1 and the second winding L2 are their eponymous end, the current outflow ends of the first winding L1 and the second winding L2 are their other set of eponymous end.

In at least one embodiment, the N first windings L1 and N second windings L2 cooperatively use the magnetic core 4.

In at least one embodiment, the lithium battery pack B includes four single batteries B1, B2, B3 and B4 connected in series. N first windings L1 having same coil turns includes four windings L11, L21, L31 and L41. N second windings L2 having same coil turns includes four windings L12, L22, L32 and L42. The 2n switches includes 8 switches S11, S12, S21, S22, S31, S32, S41 and S42. The switches can be but are not limited to transistor or MOS tube. The magnetic core 4 is commonly used by the windings L11, L21, L31, L41, L12, L22, L32 and L42. In details, the four first windings L1 and the four second windings L2 have common ends 1. Each first winding L1 connected in series with one switch 11 and each second winding L2 connected in series with one switch 11 form a pair of windings that are connected in parallel to a single battery, respectively. In detail, the winding L41 and the winding L42 form a pair of windings. The winding L41 is connected in series with the switch S41. The winding L42 is connected in series with the switch S42. The winding L41 and the winding L42 are connected in parallel with the positive terminal and negative terminal of the battery B4. The winding L31 and the winding L32 form a pair of windings. The winding L31 is connected in series with the switch S31. The winding L32 is connected in series with the switch S32. The winding L31 and the winding L32 are connected in parallel with the positive terminal and negative terminal of the battery B3. The winding L21 and the winding L22 form a pair of windings. The winding L21 is connected in series with the switch S21. The winding L22 is connected in series with the switch S22. The winding L21 and the winding L22 are connected in parallel with the positive terminal and negative terminal of the battery B2. The winding L11 and the winding L12 form a pair of windings. The winding L11 is connected in series with the switch S11. The winding L12 is connected in series with the switch S12. The winding L11 and the winding L12 are connected in parallel with the positive terminal and negative terminal of the battery B1.

In at least one embodiment, the magnetic core 4 can be but is not limited to at least one of a circular shape, an E type, a C type, a U type, and other suitable type of magnetic core. In this embodiment, the magnetic core 4 has a circular shape.

As shown in FIG. 3, the winding way of the winding structure of the transformer of the present disclosure is: the magnetic core 4 includes a start end 5 and an opposite end 6. The number of winding wires not less than the number of the single battery is selected, for example, four winding wires, are wound in the same direction. All winding wires are combined into a strand. All winding wires are wound around the magnetic core 4 starting from the start end 5 of the magnetic core 4 and winding in a first winding direction for a first number of coil turns to reach the opposite end 6 of the magnetic core 4. The N winding lines are not cut off and parts of the n winding lines with predefined length are reserved for intermediate taps, and then the n winding lines are continued to be wound in the first winding direction to reach the position of the start end 5 of the magnetic core 4, wherein starting threads of the n winding lines are first ends 2, the intermediate taps of the n winding lines are the common ends 1 and the ending threads of the n winding lines are second ends 3 and separated. Each winding line includes one of the first ends 2, one of the common ends 1, and one of the second ends 3, each winding wire forms a first winding L1 between the first end 2 and the common end 1, each winding wire forms a second winding L2 between the common end 1 and the second end 3.

In some embodiments, the transformer 100 further includes a transformer frame 10. The transformer frame 10 includes a plurality of first end lead pins 8, a plurality of common end lead pins 7 and a plurality of second end lead pins 9. The first ends 2 of the N winding lines are connected to the plurality of first end lead pins 8 of the transformer frame 10 respectively. The common ends 1 of the N winding lines are connected to the plurality of the common end lead pins 7 of the transformer frame 10 respectively. The second ends 3 of the N winding lines are connected to the plurality of second end lead pins 9 of the transformer frame 10 respectively. That is, the first ends 2 of all winding lines are connected to the plurality of first end lead pins 8 of the transformer frame 10 respectively, the common ends 1 of all winding lines are connected to the plurality of common end lead pins 7 respectively, and the second ends 3 of all winding lines are connected to the plurality of second end lead pins 9 respectively.

In another embodiment of the present disclosure, the winding structure of the transformer is wound in such a way: a number of winding wires not less than the number of the single battery is selected, for example, four winding wires, are wound in the same direction. All the winding wires are combined into one wire. All the winding wires are wound around the magnetic core 4 starting from the start end 5 of the magnetic core 4 in a first winding direction for a second number of coil turns, and passing through the opposite end 6 and reaching back to the start end 5 of the magnetic core 4 without cutting off. When the N winding lines reaches back to the start end 5 of the magnetic core 4, the N winding lines are not cut off and parts of the N winding lines with predefined length are reserved for intermediate taps, and then the N winding lines are continued to be wound staring from the start end 5 in the same direction as the first winding for the second number of coil turns and reaching back to the start end 5 of the magnetic core 4 again. The starting threads of the winding wires are used as the first ends 2, the intermediate taps of the N winding lines are used as the common ends 1, and the ending threads of the N winding lines are used as second ends 3 and separated. Each winding wire between the first end 2 and the common end 1, forms the first winding L1, each winding wire between the common end 1 and the second end 3, forms the second winding L2. The second number is different from the first number.

Thereby, each winding wire forms two windings according to the first end 2, the second end 3 and the common end 1. The number of windings formed by all winding wires is twice the number of the single batteries. Furthermore, in the actual winding process, in order to ensure the winding efficiency and improve the efficiency of the subsequent process, each group of windings corresponding to different single batteries is distinguished by using different colors of winding wires.

As shown in FIG. 4, the transformer frame 10 used in this embodiment is a “ [symbol] ” shaped structure. The transformer frame 10 includes three parallel sides. Each side is provided with one row of pins, for a total of three rows. Excluding reserved and repeated pins, the number of each row of pins is the same as that of the signal batteries, and the three rows of pins are a row of common end lead pins 7, a row of first end lead pins 8 and a row of second end lead pins 9. As shown in FIG. 5, the transformer coil 12 is placed in the frame between the row of the common end lead pins 7 and the row of the first end lead pins 8 of the transformer frame 10. The common ends 1 of the transformer coil 12 are connected to the common end lead pins 7 of the transformer frame 10 respectively. The first ends 2 of the transformer coil 12 are connected to the first end lead pins 8 of the transformer frame 10 respectively; the second ends 3 of the transformer coil 12 are connected to the second end lead pins 9 of the transformer frame 10 respectively.

When the transformer frame 10 is connected to the transformer coil 12, the common end lead pins 7, the first end lead pins 8, and the second end lead pins 9 on the transformer frame 10 are each numbered in the same direction, and the common end 1, the first end 2, and the second end 3 of the same color winding wire in the transformer coil 12 are connected to the same numbered lead pin in the common end lead pins 7, the first end lead pins 8, and the second end lead pins 9, respectively.

When the transformer frame 10 is connected to the battery pack, each row of pins on the transformer frame 10 are numbered in the same direction, and each set of the same numbered common end lead pins 7 are connected to the positive terminal of the single battery, and each set of the same numbered the first end lead pins 8 and the second end lead pins 9 are together connected to the negative terminal of the same single battery.

In another embodiment of the present disclosure, the pins at the position of the first end lead pins 8 of the transformer frame 10 can also be used as the second end lead pins, while the pins at the position of the second end lead pins 9 are used as the first end lead pins.

The above described is only the preferred embodiment of the present disclosure, and it should be noted that for a person of ordinary skill in the art, a number of variations and improvements can be made without departing from the premise of the creative idea of the present disclosure, and these are within the scope of protection of the present disclosure.

What is claimed is:

1. A transformer, wherein the transformer comprises a lithium battery pack, a transformer coil and 2N switches;
the lithium battery pack comprises N single batteries connected in series;
the transformer coil comprises a magnetic core, N first windings and N second windings;
the N first windings combined into one strand, the N second windings combined into one strand, are wound on the magnetic core respectively;
the N first windings and N second windings have same number of turns, same homonymous ends and same common ends;
two ends of each single battery are connected with one of N first windings and one of N second windings in parallel respectively; each first winding is connected with one switch in series; each second winding is connected with one switch in series; wherein N is a natural number greater than or equal to 1.

2. The transformer according to claim 1, wherein the N first windings and the N second windings cooperatively use the magnetic core.

3. The transformer according to claim 2, wherein the magnetic core is at least one of a circular-shape, E-type, C-type and U-type core.

4. The transformer according to claim 1, wherein the magnetic core comprises a start end and an opposite end; N winding lines are combined into one strand and wound around the magnetic core starting from the start end of the magnetic core and winding a first number of coil turns in a first winding direction to reach the opposite end of the magnetic core, wherein the N winding lines are not cut off and parts of the N winding lines with predefined length are reserved for intermediate taps, and then the N winding lines are continued to be wound in the first winding direction to reach the start end, wherein starting threads of N winding lines are first ends, the intermediate taps of the N winding lines are the common ends and ending threads of the N winding lines are second ends; each winding line comprises one of the first ends, one of the common ends, and one of the second ends, forming a first winding between the first end and the common end, and forming a second winding between the common end and the second end.

5. The transformer according to claim 4, wherein the transformer further comprises a transformer frame; the transformer frame comprises a plurality of first end lead pins, a plurality of common end lead pins and a plurality of second end lead pins; the first ends of the N winding lines are connected to the plurality of first end lead pins of the transformer frame, respectively; the common ends of the N winding lines are connected to the plurality of common end lead pins of the transformer frame, respectively; the second ends of the N winding lines are connected to the plurality of second end lead pins of the transformer frame, respectively.

6. The transformer according to claim 5, wherein the transformer frame is a “ [symbol] ” shaped structure; the transformer frame comprises three parallel sides; the three parallel sides are provided with a row of the common end lead pins, a row of the first end lead pins and a row of the second end lead pins; a number of the common end lead pins is not less than a number of the single batteries in the lithium battery pack; a number of the first end lead pins is not less than the number of the single batteries in the lithium battery pack; a number of the second end lead pins is not less than the number of the single batteries in the lithium battery pack.

7. The transformer according to claim 6, wherein the three parallel sides are non-equally spaced and cooperatively form two rectangular structures of different sizes; wherein the larger rectangular structure receives the transformer coil with completed winding.

8. The transformer according to claim 6, wherein the single battery comprises a positive terminal and a negative terminal; the common end lead pins are connected to the positive terminal of the single battery, and the first end lead pins are connected together with the second end lead pins to the negative terminal of the single battery.

9. The transformer according to claim 1, wherein the magnetic core comprises a start end and an opposite end, N winding lines are combined into one strand; the N winding lines are wound around the magnetic core starting from the start end of the magnetic core and winding a second number of coil turns in a first winding direction to pass through the opposite end of the magnetic core and then reach to the start end of the magnetic core; the N winding lines are not cut off and parts of the N winding lines with predefined length are reserved for intermediate taps; the N winding lines are continued to be wound in the first winding direction for the second number of coil turns and again returns to the start end of the magnetic core; wherein starting threads of the N winding lines are first end, the intermediate taps of the N winding lines are the common ends and ending threads of the N winding lines are second ends; each winding line forms a first winding between the first end and the common end; each winding line forms a second winding between the common end and the second end; each winding line comprises one of the first ends, one of the common ends, and one of the second ends, forming a first winding between the first end and the common end, and forming a second winding between the common end and the second end.

10. The transformer according to claim 9, wherein the transformer further comprises a transformer frame; the transformer frame comprises a plurality of first end lead pins, a plurality of common end lead pins and a plurality of second end lead pins; the first ends of the N winding lines are connected to the plurality of first end lead pins of the transformer frame, respectively; the common ends of the N winding lines are connected to the plurality of common end lead pins of the transformer frame, respectively, and the second ends of the N winding lines are connected to the plurality of the second end lead pins of the transformer frame, respectively.

11. The transformer according to claim 10, wherein the transformer frame is a “H” shaped structure; the transformer frame comprises three parallel sides; the three parallel sides are provided with a row of the plurality of common end lead pins, a row of the plurality of first end lead pins and a row of the plurality of second end lead pins; a number of the common end lead pins is not less than a number of the single batteries in the lithium battery pack; a number of the first end lead pins is not less than the number of the single batteries in the lithium battery pack; a number of the second end lead pins is not less than the number of the single batteries in the lithium battery pack.

12. The transformer according to claim 11, wherein the three parallel sides are non-equally spaced and cooperatively form two rectangular structures of different sizes; wherein the larger rectangular structure receives the transformer coil with completed winding.

13. The transformer according to claim 11, wherein the single battery comprises a positive terminal and a negative terminal; the common end lead pins are connected to the positive terminal of the single battery, and the first end lead pins and the second end lead pins are connected together to the negative terminal of the single battery.
